(19) United States
(12) Patent Application Publication
(10) Pub. No.: US 2006/0097232 A1
(43) Pub. Date: May 11, 2006

(54) Magneto rheological fluid

(75) Inventors: Toshiyuki Hakata, Hiroshima-shi (JP); Hirofumi Kawasaki, Aki-gun (JP); Nanao Horiishi, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: TODA KOGYO CORPORATION, Hiroshima-shi (JP)

(21) Appl. No.: 11/107,967

(22) Filed: Apr. 18, 2005

(30) Foreign Application Priority Data
Nov. 5, 2004 (JP) 2004-322636

(51) Int. Cl. H01B 3/24

(52) U.S. Cl. 252/570

(57) ABSTRACT

The magneto rheological fluid of the present invention comprises magnetic particles, a dispersing medium and polyethyleneoxide as a viscosity modifier, the polyethyleneoxide being contained in an amount of 0.5 to 5% by weight based on the weight of the magnetic particles. The magneto rheological fluid of the present invention can exhibit an excellent dispersion stability, and, more specifically, can exhibit an excellent dispersion stability and can be prevented from suffering from sedimentation of magnetic particles contained therein.

### BACKGROUND OF THE INVENTION

The present invention relates to a magneto rheological fluid, more particularly to a magneto rheological fluid having an excellent dispersion stability, and still more particularly, to a magneto rheological fluid which has an excellent dispersion stability and is free from sedimentation of magnetic particles contained therein.

The magneto rheological fluid means such a fluid substance whose viscosity varies by applying a magnetic field thereto such that magnetic particles contained therein are magnetized and oriented in the direction of the magnetic field to form chain-like clusters. Thus, since the viscosity of the magneto rheological fluid can be controlled by changing a strength of the magnetic field applied thereto, various studies have now been conducted for using the magneto rheological fluid in various applications such as clutches, brakes, dampers, actuators and buffers.

As an example of such a magneto rheological fluid, there have been proposed magneto rheological fluids containing magnetic particles plus various surfactants, organic bentonites, hydrogenated castor oils, etc. (Japanese Patent Application Laid-Open (KOKAI) No. 2002-121578 and Japanese Patent No. 3275412).

However, in these conventional magneto rheological fluids, magnetic particles contained therein are not fully prevented from being sedimented for a long period of time. As a result, the conventional magneto rheological fluids may fail to provide magneto rheological fluids having an excellent dispersion stability.

As the other example of the magneto rheological fluid, there have been proposed magnetic composite fluids containing agglomerated particles (clusters) composed of iron particles having a μm-order particle diameter and fine magnetite particles having a nm-order particle diameter which are adhered on the surface of the respective iron particles (Kunio SHIMADA and other 3 persons, “Hydrodynamic and Magnetic Properties of Magnetic Composite Fluid (MCF)”, Collection of Articles of Japan Institute of Mechanics (Edition B), Vol. 67, No. 664, pp. 122 to 128).

Although the above magnetic composite fluids have been developed as functional fluids capable of responding to change in polarity of a strength of magnetic field applied thereto, magnetic particles contained therein tend to be sedimented in the form of agglomerated particles (clusters) with the passage of time similarly to the above conventional magneto rheological fluids, thereby failing to stably attain a reliable magnetic response thereof. In addition, these magnetic composite fluids tend to suffer from increased viscosity owing to a high blending ratio of the fine magnetite particles, thereby failing to show a sufficient fluidity.

In addition, the magneto rheological fluid is in the form of a so-called suspension prepared by dispersing magnetic particles having a particle diameter of 1 to 100 μm in a solvent, for example, mineral oils, hydrocarbons, silicone oils and water, by adding a surfactant or a dispersion stabilizer thereto. Meanwhile, as fluids having a similar structure, there are known so-called magnetic fluids which have been already used in applications such as magnetic seals.

There are known magneto rheological fluids prepared by dispersing iron carbonyl particles as magnetic particles in a vehicle such as α-olefins using fumed silica particles as a dispersion stabilizer (Japanese Patent Application Laid-Open (KOKAI) No. 10-032114(1998)).

In addition, there are known magneto rheological fluids using a silicone oligomer-based thixotropic agent (dispersion stabilizer) as an additive for magneto rheological fluids (Japanese Patent Application Laid-Open (TOKUHYO) No. 8-502783(1996)).

Also, there are known magneto rheological fluids prepared by dispersing magnetic particles in polydimethylsiloxane as a dispersing medium using a copolymer of polydimethylsiloxane with (meth)acrylic ester and/or (meth)acrylic acid as a dispersion stabilizer (Japanese Patent Application Laid-Open (KOKAI) No. 2001-329285), and magneto rheological fluids using a clay mineral-based dispersing agent such as organic bentonites (Japanese Patent Application Laid-Open (KOKAI) No. 2002-121578).

As reported in these prior arts, the above magneto rheological fluids are characterized by using specific dispersion stabilizers therein of preventing sedimentation of the magnetic particles contained therein. However, these conventional magneto rheological fluids have failed to exhibit a sufficient effect of preventing sedimentation of the magnetic particles. Further, these conventional magneto rheological fluids tend to have such a problem that damper containers, etc., suffer from abrasion due to friction with the magnetic particles during the use thereof.

On the other hand, as magnetic fluids are known as fluids in which magnetic particles are stably dispersed therein and hardly sedimented, for example, there are known magnetic fluid compositions (magnetic fluids) which are obtained by using as magnetic particles, magnetite particles treated with a surfactant, and adding thereto at least one thixotropic agent selected from the group consisting of organic modified bentonites, lipophilic smectites, surface organic modified calcite-type sedimented calcium carbonates, hydrogenated castor oils, aliphatic amides, anhydrous silica and swelling mica organic composite materials (Japanese Patent Application Laid-Open (KOKAI) No. 6-215922(1994)). However, these magnetic fluids have a saturation magnetization value as low as about 370 Gauss (37 mT) and, therefore, may fail to exhibit sufficient magnetic properties.

Further, there are known magnetic fluids having a high concentration and a good dispersion stability, which are obtained by adsorbing N-polyalkylene polyamine-substituted alkenyl succinimide onto ferrite particles (Japanese Patent Application Laid-Open (KOKAI) No. 8-69909(1996)). Although the above magnetic fluids have a saturation magnetization value of 28.5 to 44.5 mT (285 to 445 Gauss), the magnetic properties thereof tend to be still insufficient.

Under the circumstances, as a result of the present inventors' earnest studies, it has been found that a magneto rheological fluid obtained by blending a specific amount of polyethyleneoxide in a dispersing medium in which magnetic particles are dispersed, can be prevented from suffering from sedimentation of the magnetic particles for a long period of time, and can surprisingly exhibit an excellent dispersion stability. The present invention has been attained on the basis of this finding.

Further, a magneto rheological fluid containing mixed particles obtained by blending metal oxide particles having a specific average particle diameter with magnetic particles having a specific average particle diameter at a specific blending ratio, can surprisingly exhibit an excellent dispersion stability and can be prevented from suffering from sedimentation of the magnetic particles.

### SUMMARY OF THE INVENTION

An object of the present invention is to provide a magneto rheological fluid which can be prevented from suffering from sedimentation of magnetic particles contained therein, for a long period of time, can exhibit-an excellent dispersion stability, and has a large content of the magnetic particles.

Another object of the present invention is to provide a magneto rheological fluid which can exhibit an appropriate viscosity required for magneto rheological fluids as well as excellent fluidity and dispersibility.

A further object of the present invention is to provide a magneto rheological fluid which can exhibit an excellent dispersion stability and can be prevented from suffering from sedimentation of magnetic particles contained therein.

A still further object of the present invention is to provide a magneto rheological fluid which can exhibit an excellent dispersion stability and a low yield value in viscosity, can be prevented from suffering from sedimentation of magnetic particles contained therein, and can be inhibited from causing abrasion of containers used therewith, etc.

To accomplish the aims, in a first aspect of the present invention, there is provided a magneto rheological fluid comprising magnetic particles dispersed in a dispersing medium and as a viscosity modifier, polyethyleneoxide in an amount of 0.5 to 5% by weight based on the weight of the magnetic particles.

In a second aspect of the present invention, there is provided a magneto rheological fluid comprising magnetic particles dispersed in a dispersing medium and polyethyleneoxide in an amount of 0.5 to 5% by weight based on the weight of the magnetic particles, wherein the magnetic particles comprise magnetic particles (A) having an average particle diameter of 0.3 to 10 μm and fine magnetic particles (B) having an average particle diameter of 5 to 15 nm, and a blending weight ratio of the fine magnetic particles (B) to the magnetic particles (A) is in the range of 0.8:100 to 15:100.

In a third aspect of the present invention, there is provided a magneto rheological fluid comprising magnetic particles (A′) having an average particle diameter of 0.1 to 10 μm dispersed in a dispersing medium, polyethyleneoxide in an amount of 0.5 to 5% by weight based on the weight of the magnetic particles, and metal oxide particles (C) having an average particle diameter of 2 to 50 nm, wherein a blending weight ratio of the metal oxide particles (C) to the magnetic particles (A′) is in the range of 0.8:100 to 15:100.

In a fourth aspect of the present invention, there is provided a magneto rheological fluid comprising magnetic particles dispersed in a dispersing medium, and polyethyleneoxide in an amount of 0.5 to 5% by weight based on the weight of the magnetic particles, wherein said magnetic particles are composite magnetic particles comprising magnetic particles (A) having an average particle diameter of 0.3 to 10 μm and fine inorganic particles (D) covering the surface of the respective magnetic particles (A) and having an average primary particle diameter of 5 to 30 nm, and a blending weight ratio of the fine inorganic particles (D) to the magnetic particles (A) is in the range of 0.8:100 to 15:100.

### DETAILED DESCRIPTION OF THE INVENTION

The present invention is described in detail below. First, the magnetic particles, polyethyleneoxide, dispersing medium, additives, surfactants and higher-fatty acids used in the present invention are described.

(1) Magnetic Particles:

As the magnetic particles, there may be used at least one kind of magnetic particles selected from the group consisting of alloy particles containing at least two elements selected from the group consisting of iron, cobalt and nickel; metal compound particles containing at least one element selected from the group consisting of iron, cobalt and nickel; iron particles; iron nitride particles; iron carbide particles, carbonyl iron particles; ferrite particles; and magnetite particles. Of these magnetic particles, preferred are iron particles, carbonyl iron particles, and ferrite particles such as Mn—Zn-based ferrite particles and Mn—Mg—Zn-based ferrite particles.

The content of the magnetic particles in the dispersing medium is in the range of usually 15 to 40% by volume, preferably 20 to 35% by volume. When the content of the magnetic particles is more than 40% by volume, the resultant magneto rheological fluid tends to show a too high viscosity, resulting in poor fluidity thereof. On the other hand, when the content of the magnetic particles is less than 15% by volume, the resultant magneto rheological fluid tends to be insufficient in magnetic force, thereby failing to show a sufficient change in magnetic viscosity thereof.

(2) Polyehtyleneoxide:

The polyethyleneoxide used as a viscosity modifier is obtained by subjecting polyethylene to oxidation treatment to introduce a polar group thereinto. The acid value of the polyethyleneoxide is in the range of usually 1.0 to 70 mg KOH/g, preferably 5.0 to 50 mg KOH/g. When the acid value of the polyethyleneoxide is less than 1.0 mg KOH/g, the resultant magneto rheological fluid tends to be deteriorated in dispersion stability. On the other hand, when the acid value of the polyethyleneoxide is more than 70 mg KOH/g, the resultant magneto rheological fluid tends to show a too high viscosity, resulting in poor fluidity thereof. The polyethyleneoxide has a number-average molecular weight of usually 1000 to 5000, preferably 1500 to 4000. When the number-average molecular weight of the polyethyleneoxide is less than 1000, the effect of preventing sedimentation of the magnetic particles tends to be deteriorated. On the other hand, when the number-average molecular weight of the polyethyleneoxide is more than 5000, the resultant magneto rheological fluid tends to show a too high viscosity, resulting in poor fluidity thereof.

The amount of the polyethyleneoxide blended is in the range of usually 0.5 to 5% by weight, preferably 0.5 to 3% by weight, more preferably 0.7 to 2% by weight based on the weight of the magnetic particles. When the amount of the polyethyleneoxide blended is less than 0.5% by weight, the resultant magneto rheological fluid tends to be deteriorated in dispersion stability, namely tends to suffer from sedimentation of the magnetic particles with the passage of time. On the other hand, when the amount of the polyethyleneoxide blended is more than 5% by weight, the resultant magneto rheological fluid tends to show a too high viscosity, resulting in poor fluidity thereof.

(3) Dispersing Medium:

As the dispersing medium, there may be used hydrocarbon-based solvents, glycol-based solvents and silicone-based solvents. These dispersing media may be used singly or, if required, in combination of any two or more thereof. Examples of the hydrocarbon-based solvents may include normal paraffins, isoparaffins, paraffin-based lubricants or the like. Examples of the glycol-based solvents may include diethylene glycol monoethylene ethyl ether or the like. Examples of the silicone-based solvents may include silicone oils such as polydimethylsiloxane, or the like.

(4) Additives:

In the present invention, in order to further enhance the dispersion stability and fluidity of the magneto rheological fluid, the following additives may be blended in the magneto rheological fluid composed of the above components. Examples of the additives may include (a) heat-stable hydrogenated castor oils obtained by hydrogenating double bonds of castor oil, (b) amide waxes synthesized from vegetable oil fatty acid and amine, (c) clay mineral montmorillonite or bentonite obtained by treating the surface of crystals thereof with a quaternary ammonium salt or an organic amine salt, or the like. These additives may be used singly or, if required, in combination of any two or more thereof.

The amount of the additives blended is usually not more than 5% by weight, preferably 0.1 to 5% by weight, more preferably 0.5 to 3% by weight based on the weight of the magnetic particles. When the amount of the additives blended is more than 5% by weight, the resultant magneto rheological fluid tends to show a too high viscosity, resulting in poor fluidity thereof.

(5) Surfactant and Higher-Fatty Acid:

In addition, in order to further enhance a fluidity of the magneto rheological fluid, a surfactant or a higher-fatty acid may be added thereto. As the surfactant, there may be used those surfactants having functional groups showing a good affinity to the dispersing medium. Specific examples of the surfactant may include alkali metal salts or ammonium salts of higher-fatty acids, sorbitan aliphatic acid esters or the like. Specific examples of the higher-fatty acids may include caproic acid, lauric acid, myristic acid, palmitic acid, stearic acid, oleic acid or the like.

The amount of the surfactant or the higher-fatty acid blended is usually not more than 5% by weight, preferably 0.1 to 5% by weight, more preferably 0.5 to 3% by weight based on the weight of the magnetic particles. When the amount of the surfactant or the higher-fatty acid blended is more than 5% by weight, the resultant magneto rheological fluid tends to be deteriorated in fluidity.

The features of the present invention are set forth below.

The magneto rheological fluid according to the first aspect of the present invention is characterized by containing polyethyleneoxide as a viscosity modifier in an amount of 0.5 to 5% by weight based on the magnetic particles.

The magnetic particles have a particle diameter of usually 0.1 to 50 μm, preferably 0.3 to 10 μm. When the particle diameter of the magnetic particles is more than 50 μm, the resultant magneto rheological fluid tends to be deteriorated in dispersion stability. On the other hand, when the particle diameter of the magnetic particles is less than 0.1 μm, the resultant magneto rheological fluid may fail to show a sufficient viscosity change in response to application or non-application of a magnetic field thereto, resulting in poor effect of magnetic viscosity.

The magneto rheological fluid of the present invention has a viscosity (at a shear rate of 100 sec⁻¹) of usually 50 to 250 mPa·s, preferably 60 to 200 mpa·s as measured by an E-type viscometer; a thixotropy index of usually not less than 5, preferably 5 to 15, more preferably 6 to 13; and a sedimentation degree (as an index of dispersibility) of usually 0 to 5 mL, preferably 0 to 3 mL.

The magneto rheological fluid according to the second aspect of the present invention is characterized by containing polyethyleneoxide in an amount of usually 0.5 to 5% by weight based on the weight of the magnetic particles, and using as the magnetic particles, magnetic particles (A) having an average particle diameter of usually 0.3 to 10 μm as well as fine magnetic particles (B) having an average particle diameter of usually 5 to 15 nm, wherein the blending weight ratio of the fine magnetic particles (B) to the magnetic particles (A) is in the range of usually 0.8:100 to 15:100.

Thus, the magnetic particles used in the second aspect of the present invention are mixed particles containing a specific amount of the magnetic particles (A) and a specific amount of the fine magnetic particles (B) which are different in average particle diameter from each other. In the magneto rheological fluid, the fine magnetic particles (B) are adhered onto a part of the surface of the respective magnetic particles (A), or present between the magnetic particles (A), thereby preventing adhesion between the magnetic particles (A). As a result, it is considered that the magneto rheological fluid can show excellent fluidity and dispersibility without increase in viscosity thereof.

The fine magnetic particles (B) have an average particle diameter of usually 5 to 15 nm, preferably 7 to 10 nm. When the average particle diameter of the fine magnetic particles (B) is more than 15 nm, the residual magnetization value thereof tends to be increased, resulting in agglomeration between the fine magnetic particles (B). As a result, the obtained magneto rheological fluid tends to be deteriorated in sedimentation property. On the other hand, when the average particle diameter of the fine magnetic particles (B) is less than 5 nm, the resultant magneto rheological fluid tends to show a too high viscosity, resulting in poor fluidity thereof.

The magnetic particles (A) have an average particle diameter of usually 0.3 to 10 μm, preferably 0.4 to 5 μm. When the average particle diameter of the magnetic particles (A) is more than 10 μm, the residual magnetization value thereof tends to be increased, resulting in agglomeration between the magnetic particles (A). As a result, the obtained magneto rheological fluid tends to be deteriorated in sedimentation property. On the other hand, when the average particle diameter of the magnetic particles (A) is less than 0.3 μm, the resultant magneto rheological fluid tends to show a too high viscosity, resulting in poor fluidity thereof.

The blending weight ratio of the fine magnetic particles (B) to the magnetic particles (A) is in the range of usually 0.8:100 to 15:100, preferably 1:100 to 10:100. When the blending weight ratio of the fine magnetic particles (B) to the magnetic particles (A) is less than 0.8:100, the effect of addition of the fine magnetic particles (B) tends to be insufficient, resulting in agglomeration between the magnetic particles (A). As a result, the obtained magneto rheological fluid tends to be deteriorated in sedimentation property. On the other hand, when the blending weight ratio of the fine magnetic particles (B) to the magnetic particles (A) is more than 15:100, the resultant magneto rheological fluid tends to show a too high viscosity, resulting in poor fluidity thereof.

The magneto rheological fluid according to the second aspect of the present invention has a viscosity (at a shear rate of 100 sec⁻¹) of usually 50 to 500 mPa·s, preferably 60 to 370 mPa·s as measured by an E-type viscometer; a thixotropy index of usually 5 to 15, preferably 6 to 14; and a sedimentation degree (as an index of dispersibility) of usually 0 to 4 mL, preferably 0 to 3.5 mL.

The magneto rheological fluid according to the third aspect of the present invention is characterized by containing polyethyleneoxide in an amount of usually 0.5 to 5% by weight based on the weight of the magnetic particles and the metal oxide particles (C) having an average particle diameter of 2 to 50 nm, using magnetic particles (A′) having an average particle diameter of usually 0.1 to 10 μm as the magnetic particles, wherein the blending weight ratio of the metal oxide particles (C) to the magnetic particles (A′) is in the range of usually 0.8:100 to 15:100.

The magnetic particles (A′) have an average particle diameter of usually 0.1 to 10 μm, preferably 0.3 to 5 μm. When the average particle diameter of the magnetic particles (A′) is more than 10 μm, the residual magnetization value thereof tends to be increased, resulting in agglomeration between the magnetic particles (A′). As a result, the obtained magneto rheological fluid tends to be deteriorated in sedimentation property. On the other hand, when the average particle diameter of the magnetic particles (A′) is less than 0.1 μm, the resultant magneto rheological fluid tends to show a too high viscosity, thereby failing to increase the concentration of the magnetic particles therein.

As the metal oxide particles, there may be used at least one kind of metal oxide particles selected from the group consisting of silica particles, alumina particles and titanium oxide particles. There may also be used particles obtained by surface-treating these metal oxide particles.

The metal oxide particles (C) have an average particle diameter of usually 2 to 50 nm, preferably 5 to 50 nm, more preferably 5 to 30 nm. When the average particle diameter of the metal oxide particles (C) is more than 50 nm, the magnetic particles tend to be agglomerated together, so that the obtained magneto rheological fluid tends to be deteriorated in sedimentation property. On the other hand, when the average particle diameter of the metal oxide particles (C) is less than 2 nm, the resultant magneto rheological fluid tends to show a too high viscosity, thereby failing to increase the concentration of the magnetic particles therein.

The metal oxide particles (C) preferably have a BET specific surface area of usually not less than 100 m²/g, more preferably 100 to 300 m²/g, still more preferably 150 to 300 m²/g.

The blending weight ratio of the metal oxide particles (C) to the magnetic particles (A′) (C/A′) is in the range of usually 0.8:100 to 15:100, preferably 0.8:100 to 10:100, more preferably 0.8:100 to 3:100. When the blending weight ratio (C/A′) is less than 0.8:100, the effect of addition of the metal oxide particles (C) tends to be insufficient, resulting in sedimentation of the magnetic particles. On the other hand, when the blending weight ratio (C/A′) is more than 15:100, the resultant magneto rheological fluid tends to show a too high viscosity, thereby failing to increase the concentration of the magnetic particles therein.

The magneto rheological fluid according to the third aspect of the present invention has a viscosity of usually 100 to 500 mPa·s, preferably 200 to 400 mpa·s; a thixotropy index of usually 5 to 30, preferably 5 to 20 as measured by the below-mentioned evaluation method; a sedimentation property of usually not more than 3 mL, preferably not more than 2 mL; and a saturation magnetization value of usually 150 to 300 mT, preferably 170 to 300 mT.

The magneto rheological fluid according to the fourth aspect of the present invention is characterized by containing polyethyleneoxide in an amount of usually 0.5 to 5% by weight based on the weight of the magnetic particles, and using as the magnetic particles, composite magnetic particles composed of magnetic particles (A) having an average particle diameter of usually 0.3 to 10 μm and fine inorganic particles (D) covering the surface of the respective magnetic particles (A) and having an average primary particle diameter of usually 5 to 20 nm, and the blending weight ratio of the fine inorganic particles (D) to the magnetic particles (A) is in the range of usually 0.8:100 to 15:100.

Thus, the magnetic particles used in the magneto rheological fluid according to the fourth aspect of the present invention, are composite magnetic particles composed of the magnetic particles (A) and the fine inorganic particles (D) covering the surface of the respective magnetic particles (A). The composite particles have an average particle diameter of usually 0.3 to 10 μm, preferably 0.4 to 5.0 μm.

The magnetic particles (A) used in the magneto rheological fluid according to the fourth aspect of the present invention, have an average particle diameter of usually 0.3 to 10 μm, preferably 0.4 to 5 μm. When the average particle diameter of the magnetic particles (A) is more than 10 μm, the obtained magneto rheological fluid tends to be deteriorated in sedimentation property. On the other hand, when the average particle diameter of the magnetic particles (A) is less than 0.3 μm, the resultant magneto rheological fluid tends to show a too high viscosity, thereby failing to increase the concentration of the magnetic particles therein.

As the fine inorganic particles (D), there may be used either magnetic particles and/or non-magnetic particles. For example, as the fine inorganic particles (D), there are preferably used iron oxide particles. Specific examples of such particles may include at least one kind of fine inorganic particles selected from the group consisting of ferrite particles, magnetite particles and maghemite particles. In addition, as the fine inorganic particles (D), there may also be used at least one kind of fine inorganic particles selected from the group consisting of silica particles, alumina particles and titanium oxide particles.

The fine inorganic particles (D) have an average primary particle diameter of usually 5 to 20 nm, preferably 5 to 15 nm, more preferably 7 to 10 nm. When the average primary particle diameter of the fine inorganic particles (D) is more than 20 nm, the residual magnetization value thereof tends to be increased, resulting in agglomeration between the magnetic particles. As a result, the obtained magneto rheological fluid tends to be deteriorated in sedimentation property. On the other hand, when the average primary particle diameter of the fine inorganic particles (D) is less than 5 nm, the resultant magneto rheological fluid tends to show a too high viscosity, thereby failing to increase the concentration of the magnetic particles therein.

The composite magnetic particles of the present invention have such a layer structure in which the surface of the respective magnetic particles (A) is coated with the fine inorganic particles (D). The ratio of a thickness of the coating layer composed of the fine inorganic particles (D) to a diameter of the respective magnetic particles (A) as core particles is usually in the range of 5:10000 to 20:100, preferably 1:1000 to 10:100. When the ratio is less than 5:10000, the effect of addition of the fine inorganic particles (D) tends to be insufficient, resulting in sedimentation of the magnetic particles. On the other hand, when the ratio is more than 20:100, the resultant magneto rheological fluid tends to show a too high viscosity, thereby failing to increase the concentration of the magnetic particles therein.

The weight ratio of the fine inorganic particles (D) to the magnetic particles (A) is in the range of usually 0.8:100 to 15:100, preferably 0.8:100 to 10:100. When the weight ratio of the fine inorganic particles (D) to the magnetic particles (A) is less than 0.8:100, the effect of addition of the fine inorganic particles (D) tends to be insufficient, resulting in sedimentation of the magnetic particles. On the other hand, when the weight ratio of the fine inorganic particles (D) to the magnetic particles (A) is more than 15:100, the resultant magneto rheological fluid tends to show a too high viscosity, thereby failing to increase the concentration of the magnetic particles therein.

The magneto rheological fluid according to the fourth aspect of the present invention has a viscosity of usually 100 to 500 mPa·s, preferably 200 to 400 mPa·s; a thixotropy index of usually 5 to 30, preferably 5 to 20 as measured by the below-mentioned evaluation method; a sedimentation property of usually not more than 3 mL, preferably not more than 2 mL; and a saturation magnetization value of usually 150 to 300 mT, preferably 170 to 300 mT.

Next, the process for producing the magneto rheological fluid according to the present invention is described.

The process for producing the magneto rheological fluid according to each of the first to third aspects of the present invention is not particularly limited. For example, there may be used such a method of mixing the magnetic particles together with the viscosity modifier and the dispersing medium using a treating apparatus capable of applying a high shear force thereto, such as a homogenizer, a ball mill and a mechanical mixer. In the case where the viscosity modifier is fully dispersed using the treating apparatus so as to effectively exhibit its effect, it is possible to obtain a magneto rheological fluid in which the magnetic particles are stably dispersed.

In addition, the process for producing the magneto rheological fluid according to the fourth aspect of the present invention may be conducted by the following method.

That is, firstly, as a pretreatment before the mixing procedure, polyethyleneoxide particles are melted in a paraffin-based oil as a dispersing medium by heating to a temperature not less than a melting point thereof. While keeping the above condition, the magnetic particles and the fine inorganic particles, if required, together with various viscosity modifiers or surfactants, additives such as bentonite and oleic acid, are added to the resultant fluid, and the resultant mixture is once cooled to a temperature of 35 to 45° C., and mixed and dispersed using a homomixer, etc. Further, the temperature of the obtained mixture is raised to a temperature near a softening point of the polyethyleneoxide, thereby obtaining a dispersion wherein composite magnetic particles having such a layer structure in which the fine inorganic particles are adhered onto the surface of the respective magnetic particles are dispersed in the paraffin-based oil as a dispersing medium. Meanwhile, it is preferred that the fine inorganic particles are previously dispersed in an appropriate dispersing medium.

Next, the resultant dispersion is subjected to the mixing treatment. Although the mixing method is not particularly limited, the mixing treatment is preferably conducted using a treating apparatus capable of applying a high shear force such as a homogenizer, a ball mill and a mechanical mixer. When the dispersion is fully dispersed using such a treating apparatus, the viscosity modifier can exhibit its sufficient effect, so that it is possible to obtain a magneto rheological fluid having an excellent dispersion stability.

Meanwhile, upon the mixing treatment, fine bubbles tend to be mixed in the fluid, resulting in problems concerning stability with the passage of time as well as response characteristic of damping force to a magnetic field applied. Therefore, upon the mixing treatment, the dispersion is preferably fully deaerated.

The above-described magneto rheological fluid of the present invention can be prevented from suffering from sedimentation of magnetic particles contained therein, for a long period of time, and can exhibit an excellent dispersion stability. Therefore, the magneto rheological fluid of the present invention can be effectively used as a rheological fluid in clutches, brakes, actuators, etc.

Further, in the magneto rheological fluid according to the third aspect of the present invention, the polyethyleneoxide is used together with the metal oxide particles such as silica, alumina and titanium oxide. As a result, the metal oxide particles are present between the magnetic particles and function as a spacer therefor, so that the resultant magneto rheological fluid can exhibit an excellent dispersibility even at a high concentration thereof, and can be prevented from suffering from sedimentation of the magnetic particles contained therein. Further, the magneto rheological fluid can be inhibited from causing abrasion of containers used therewith, etc.

In addition, in the magneto rheological fluid according to the fourth aspect of the present invention, since a coating layer composed of the fine inorganic particles is formed on the surface of the respective magnetic particles, magnetic agglomeration between the magnetic particles can be effectively prevented, so that the magnetic particles can maintain a good dispersibility in the magneto rheological fluid and can be prevented from being sedimented.

According to the present invention, there can be obtained a magneto rheological fluid exhibiting an appropriate viscosity and an excellent fluidity. Further, since the magnetic particles contained in the magneto rheological fluid can be prevented from being sedimented for a long period of time, there can be provided such a magneto rheological fluid exhibiting a good dispersion stability for a long period of time and having a high content of magnetic particles therein. Therefore, the present invention can show a remarkable industrial value.

Specifically, the magneto rheological fluid according to the third aspect of the present invention can maintain an excellent magnetic viscosity as well as a good dispersion stability for a long period of time.

In addition, the magneto rheological fluid according to the fourth aspect of the present invention can exhibit a high saturated magnetization value, a low yield value in viscosity and excellent dispersion stability for a long period of time, and can be prevented from suffering from sedimentation of the magnetic particles contained therein. Therefore, the magneto rheological fluid can be usefully applied to clutches, dampers, actuators, etc.

### EXAMPLES

The present invention is described in more detail below by Examples, but the Examples are only illustrative and, therefore, not intended to limit the scope of the present invention. Meanwhile, various properties described in the present invention were measured by the following methods.

(1) The viscosity was measured at 25° C. using an E-type viscometer “TV-30” manufactured by Toki Sangyo Co., Ltd.

(2) The yield value was measured at 25° C. using an E-type viscometer “TV-30” manufactured by Toki Sangyo Co., Ltd.

(3) The thixotropy index was expressed by a ratio of the viscosity at a shear rate of 3.83 sec⁻¹ to that at a shear rate of 38.3 sec⁻¹ as measured using the above E-type viscometer.

(4) The sedimentation degree was expressed by a volume (mL) of a supernatant layer obtained by filling 50 mL of the magneto rheological fluid in a 100 mL measuring cylinder and then allowing the fluid to stand at a temperature of 60° C. for one month.

(5) The Saturation magnetization of the magneto rheological fluid were measured using a vibration sample magnetometer “VSM-3S-15” (manufactured by Toei Kogyo Co., Ltd.) by applying an external magnetic field of 796 kA/m thereto.

(6) The structure of the magnetic particles was determined by observing an image of a section of the magnetic particle cut by an FIB (focused ion beam) apparatus. Meanwhile, the diameter of the magnetic particles (A) and the thickness of the coating layer composed of the fine inorganic particles were measured to calculate a ratio of the thickness of the coating layer to the diameter of the magnetic particles (A).

<Magneto Rheological Fluid According to the First Aspect of the Present Invention>

### Examples 1 to 5 and Comparative Examples 1 to 4

The respective components were mixed with each other at a blending ratio shown in Tables 1 to 2, thereby producing magneto rheological fluids. The viscosity, thixotropy index, sedimentation degree and magnetic properties of the thus obtained magneto rheological fluids were measured by the above methods. The results are shown in Tables 1 to 2.

TABLE 1

| | Examples | | | | |
|---|---|---|---|---|---|
| | 1 | 2 | 3 | 4 | 5 |
| Composition | | | | | |
| Dispersing medium | | | | | |
| Normal paraffin | 330 g | 300 g | — | — | 300 g |
| Paraffin-based lubricant | — | — | 270 g | 250 g | — |
| Magnetic particles | | | | | |
| Carbonyl iron (1) (2.6 μm) | 1000 g | 700 g | — | — | — |
| Carbonyl iron (2) (1.9 μm) | — | — | 700 g | — | — |
| Carbonyl iron (3) (5.1 μm) | — | 300 g | 300 g | — | — |
| Iron (0.5 μm) | — | — | — | 1000 g | — |
| Mn—Zn ferrite (2.1 μm) | — | — | — | — | 1000 g |
| Polyethyleneoxide (1) | 10 g | — | — | — | 8 g |
| Polyethyleneoxide (2) | — | 12 g | — | — | — |
| Polyethyleneoxide (3) | — | — | 18 g | — | — |
| Polyethyleneoxide (4) | — | — | — | 15 g | — |
| Additives | | | | | |
| Bentonite (1) | 2 g | — | — | — | — |
| Bentonite (2) | — | — | — | — | 2 g |
| Bentonite (3) | — | — | — | — | — |
| Hydrogenated castor oil (1) | — | 4 g | — | — | — |
| Hydrogenated castor oil (2) | — | — | — | — | — |
| Amide wax | — | — | 3 g | — | — |
| Oleic acid | — | — | — | 1 g | — |
| Content of magnetic | 23 | 25 | 30 | 33 | 31 |
| particles (% by volume) | | | | | |
| Various properties | | | | | |
| Viscosity | 107 | 112 | 125 | 94 | 190 |
| (shear rate: 100 sec⁻¹) | | | | | |
| (mP · s) | | | | | |
| Thixotropy Index | 11 | 12 | 8.5 | 7.5 | 12 |
| Sedimentation degree (mL) | 1.8 | 2.0 | 1.0 | 1.2 | 2.5 |

TABLE 2

| | Comparative Examples | | | |
|---|---|---|---|---|
| Composition | 1 | 2 | 3 | 4 |
| Dispersing medium | | | | |
| Normal paraffin | 320 g | 280 g | 270 g | 300 g |
| Paraffin-based lubricant | — | — | — | — |
| Magnetic particles | | | | |
| Carbonyl iron (1) (2.6 μm) | — | 1000 g | 1000 g | 1000 g |
| Carbonyl iron (2) (1.9 μm) | — | — | — | — |
| Carbonyl iron (3) (5.1 μm) | — | — | — | — |
| Iron (0.5 μm) | — | — | — | — |
| Mn—Zn ferrite (2.1 μm) | 1000 g | — | — | — |
| Polyethyleneoxide (1) | — | — | 3 g | 90 g |
| Polyethyleneoxide (2) | — | — | — | — |
| Polyethyleneoxide (3) | — | — | — | — |
| Polyethyleneoxide (4) | — | — | — | — |
| Additives | | | | |
| Bentonite (1) | — | — | 2 g | — |
| Bentonite (2) | — | — | — | — |
| Bentonite (3) | — | 20 g | — | — |
| Hydrogenated castor oil (1) | — | — | — | — |
| Hydrogenated castor oil (2) | 15 g | — | — | — |
| Amide wax | — | — | — | — |
| Oleic acid | — | — | — | — |
| Content of magnetic | 30 | 26 | 30 | 25 |
| particles (% by volume) | | | | |
| Various properties | | | | |
| Viscosity (shear rate: 100 sec⁻¹) | 305 | 225 | 40 | 526 |
| (mP · s) | | | | |
| Thixotropy Index | 4 | 3 | 3.8 | 17.8 |
| Sedimentation degree (mL) | 6.2 | 9.2 | 12.5 | 6.7 |

In Tables 1 to 2, the following commercial products were used as the respective components.

Normal paraffin: “SN-NP™” produced by Nikko Seiyu Kagaku Co., Ltd.;

Paraffin-based lubricant: “SUPER OIL M22™” produced by Shin-Nihon Sekiyu Co., Ltd.;

Carbonyl iron (1): “S-3700™” produced by ISP Co., Ltd. (average particle diameter: 2.6 μm);

Carbonyl iron (2): “S-3000™” produced by ISP Co., Ltd. (average particle diameter: 1.9 μm);

Carbonyl iron (3): “S-1651™” produced by ISP Co., Ltd. (average particle diameter: 5.1 μm);

Polyethyleneoxide (1): “HIGH-WAX 4052E™” produced by Mitsubishi Kagaku Co., Ltd. (acid value: 20 mg KOH/g; number-average molecular weight: 3200);

Polyethyleneoxide (2): “HIGH-WAX 4051E™” produced by Mitsubishi Kagaku Co., Ltd. (acid value: 12 mg KOH/g; number-average molecular weight: 3200);

Polyethyleneoxide (3): “DISPALON TP-203™” produced by Kusumoto Kasei Co., Ltd. (acid value: 12 mg KOH/g; number-average molecular weight: 3000);

Polyethyleneoxide (4): “HIGH-WAX 2203A™” produced by Mitsubishi Kagaku Co., Ltd. (acid value: 30 mg KOH/g; number-average molecular weight: 2700);

Bentonite (1): “HYDROCALL ONZ™” produced by Allied Colloid Inc.;

Bentonite (2): “ESBEN W™” produced by Hojun Co., Ltd.;

Bentonite (3): “ESBEN N-400™” produced by Hojun Co., Ltd.;

Hydrogenated castor oil (1): “SN THICKENER 4040™” produced by Sun Nopco Co., Ltd.;

Hydrogenated castor oil (2): “DISPALON 305™” produced by Kusumoto Kasei Co., Ltd.; and

Amide wax: “SN THICKENER 4030™” produced by Sun Nopco Co., Ltd.

From the above results showing in the Tables 1 to 2, it was apparently confirmed that the magneto rheological fluids according to the present invention exhibited a small sedimentation degree and an excellent dispersion stability.

<Magneto Rheological Fluid According to the Second Aspect of the Present Invention>

### Example 6

150.8 g of a 1.4M FeSO₄ aqueous solution and 123 mL of a 2.8M FeCl₃ aqueous solution were dropped into 690 mL of a 3.27N NaOH aqueous solution at 80° C. while stirring, and then the resultant mixed solution was aged at 80° C. for one hour. After cooling, the obtained reaction solution was subjected to decantation to remove salts therefrom, thereby obtaining a suspension containing magnetite particles (magnetic particles (B)) having a particle diameter of 10 nm in an amount of 50% by weight.

The resultant suspension was mixed with 46 g of a 10% sodium oleate aqueous solution, thereby obtaining 231 g of oleic acid-coated magnetite particles. Then, the thus obtained oleic acid-coated magnetite particles were dispersed in 120 g of a paraffin-based oil “SUPER OIL M10™” produced by Shin-Nihon Sekiyu Co., Ltd., thereby obtaining an oil-based fine particulate magnetic paste.

Next, 1 kg of carbonyl iron (“MSP3700™” produced by ISP Co., Ltd.; magnetic particles (A)) having a particle diameter of 2.6 μm, 30 g of the above fine particulate magnetic paste (content of magnetite particles: 20 g), 10 g of polyethyleneoxide (“HIGH-WAX 4052E™” produced by Mitsui Kagaku Co., Ltd.), 2 g of bentonite (“HYDROCALL ONZ™” produced by Allied Colloid Inc.) and 200 g of the paraffin-based oil “SUPER OIL M10™” produced by Shin-Nihon Sekiyu Co., Ltd., were mixed with each other using a homomixer, thereby obtaining a magneto rheological fluid. As a result of observing magnetic particles dispersed in the obtained magneto rheological fluid using a scanning electron micrograph thereof, it was confirmed that the magnetic particles had such a structure in which the fine magnetic particles (B) were adhered onto the surface of the respective magnetic particles (A), and a substantially whole amount of the fine magnetic particles (B) were adhered onto the surface of the respective magnetic particles (A). Further, it was confirmed that the obtained magneto rheological fluid had a viscosity of 256 mPa·s, a thixotropy index of 7 and a sedimentation degree of 1.2 mL.

### Examples 7 to 10

The same procedure as defined in Example 6 was conducted except that the respective components shown in Tables 4 and 5 were used at a blending ratio as shown, thereby producing magneto rheological fluids. The viscosity, thixotropy index and sedimentation degree of the thus obtained magneto rheological fluids were measured by the above methods. The results are shown in Tables 3 and 4.

### Comparative Examples 4 and 5

The same procedure as defined in Example 6 was conducted except that the respective components shown in Tables 3 and 4 were used at a blending ratio as shown, thereby producing magneto rheological fluids. The viscosity, thixotropy index and sedimentation degree of the thus obtained magneto rheological fluids were measured by the above methods. The results are shown in Tables 3 and 4.

TABLE 3

| | Examples | | |
|---|---|---|---|
| Composition | 6 | 7 | 8 |
| Dispersing medium (g) | | | |
| Hydrocarbon-based solvent (1) | 300 | 320 | — |
| Hydrocarbon-based solvent (2) | | | 250 |
| Hydrocarbon-based solvent (3) | — | — | — |
| Fine magnetic particles (B) | | | |
| Magnetite (g) | 20 | 23 | 13 |
| Average diameter (nm) | 10 | 8 | 10 |
| Amount of paste (g) | 30 | 35 | 20 |
| Magnetic particles (A) | | | |
| Carbonyl iron (1) (g) | 1000 | — | 1000 |
| Carbonyl iron (2) (g) | — | 1000 | — |
| Iron (g) | — | — | — |
| Mn—Zn ferrite (g) | — | — | — |
| Average diameter (μm) | 2.6 | 1.9 | 2.6 |
| Weight ratio B/A | 2/100 | 2.3/100 | 1.3/100 |
| Content of magnetic | 28 | 26 | 31 |
| particles (% by volume) | | | |
| Polyethyleneoxide (1) (g) | 10 | — | — |
| Polyethyleneoxide (2) (g) | — | 15 | — |
| Polyethyleneoxide (3) (g) | — | — | 18 |
| Polyethyleneoxide (4) (g) | — | — | — |
| Additives | | | |
| Bentonite (1) (g) | 2 | — | — |
| Bentonite (2) (g) | — | 3 | — |
| Hydrogenated castor oil (g) | — | — | — |
| Amide wax | — | — | 3 |
| Various properties | | | |
| Viscosity (shear rate: 100 sec⁻¹) | 256 | 185 | 286 |
| (mP · s) | | | |
| Thixotropy Index | 7 | 6 | 11 |
| Sedimentation degree (mL) | 1.2 | 1.8 | 1.6 |

TABLE 4

| | | | Comparative | |
|---|---|---|---|---|
| | Examples | | Examples | |
| Composition | 9 | 10 | 4 | 5 |
| Dispersing medium (g) | | | | |
| Hydrocarbon-based solvent (1) | — | — | — | 350 |
| Hydrocarbon-based solvent (2) | 300 | — | 350 | — |
| Hydrocarbon-based solvent (3) | — | 400 | — | — |
| Fine magnetic particles (B) | | | | |
| Magnetite (g) | 10 | 16 | — | 33 |
| Average diameter (nm) | 8 | 10 | — | 10 |
| Amount of paste (g) | 15 | 25 | — | 50 |
| Magnetic particles (A) | | | | |
| Carbonyl iron (1) (g) | — | — | 1000 | — |
| Carbonyl iron (2) (g) | — | — | — | 1000 |
| Iron (g) | 1000 | — | — | — |
| Mn—Zn ferrite (g) | — | 1000 | — | — |
| Average diameter (μm) | 0.5 | 2.1 | 2.6 | 1.9 |
| Weight ratio B/A | 1/100 | 1.6/100 | — | 3.3/100 |
| Content of magnetic | 29 | 30 | 24 | 25 |
| particles (% by volume) | | | | |
| Polyethyleneoxide (1) (g) | — | 10 | — | — |
| Polyethyleneoxide (2) (g) | — | — | — | — |
| Polyethyleneoxide (3) (g) | — | — | — | — |
| Polyethyleneoxide (4) (g) | 15 | — | — | — |
| Additives | | | | |
| Bentonite (1) (g) | — | 2 | — | 20 |
| Bentonite (2) (g) | — | — | — | — |
| Hydrogenated castor oil (g) | — | — | 15 | — |
| Amide wax | — | — | — | — |
| Various properties | | | | |
| Viscosity (shear rate: 100 sec⁻¹) | 195 | 368 | 226 | 256 |
| (mP · s) | | | | |
| Thixotropy Index | 6 | 14 | 4 | 7 |
| Sedimentation degree (mL) | 2.8 | 1.6 | 9.0 | 4.3 |

In Tables 3 to 4, the following commercial products were used as the respective components.

Hydrocarbon-based solvent (1): “SUPER OIL M10™” produced by Shin-Nihon Sekiyu Co., Ltd.;

Hydrocarbon-based solvent (2): “TURBINE OIL 46™” produced by Shin-Nihon Sekiyu Co., Ltd.;

Hydrocarbon-based solvent (3): “CRYSEF OIL F22™” produced by Shin-Nihon Sekiyu Co., Ltd.;

Carbonyl iron (1): “S-3700™” produced by ISP Co., Ltd.;

Carbonyl iron (2): “S-3000™” produced by ISP Co., Ltd.;

Polyethyleneoxide (1): “HIGH-WAX 4052E™” produced by Mitsubishi Kagaku Co., Ltd. (acid value: 20 mg KOH/g; number-average molecular weight: 3200);

Polyethyleneoxide (2): “HIGH-WAX 4051E™” produced by Mitsubishi Kagaku Co., Ltd. (acid value: 12 mg KOH/g; number-average molecular weight: 3200);

Polyethyleneoxide (3): “DISPALON TP-203™” produced by Kusumoto Kasei Co., Ltd. (acid value: 12 mg KOH/g; number-average molecular weight: 3000);

Polyethyleneoxide (4): “HIGH-WAX 2203A™” produced by Mitsubishi Kagaku Co., Ltd. (acid value: 30 mg KOH/g; number-average molecular weight: 2700);

Bentonite (1): “HYDROCALL ONZ™” produced by Allied Colloid Inc.;

Bentonite (2): “ESBEN W™” produced by Hojun Co., Ltd.; Amide wax: “SN THICKENER 4030™” produced by Sun Nopco Co., Ltd.; and

Hydrogenated castor oil (1): “DISPALON 305™” produced by Kusumoto Kasei Co., Ltd.

From the above results showing in the Table 3 to 4, it was apparently confirmed that the magneto rheological fluids according to the present invention exhibited a desired viscosity, an excellent fluidity, a small sedimentation degree and an excellent dispersibility.

<Magneto Rheological Fluid According to the Third Aspect of the Present Invention>

### Example 11

1 kg of carbonyl iron (“MSP-3700™” produced by ISP Co., Ltd.), 10 g of silica particles (“FINE SEAL T-30™” produced by Tokuyama Co., Ltd.) having an average particle diameter of 15 nm, 10 g of polyethyleneoxide (“HIGH-WAX 4052E™” produced by Mitsui Kagaku Co., Ltd.), 2 g of bentonite (“HYDROCALL ONZ™” produced by Allied Colloid Inc.) and 200 g of a paraffin-based oil “SUPER OIL M10™” , were mixed with each other at 80° C. for 30 min using a homomixer, thereby obtaining a magneto rheological fluid.

It was confirmed that the obtained magneto rheological fluid had a viscosity of 285 mPa·s, a thixotropy index of 7 and a sedimentation degree of 1.0 mL.

### Examples 12 to 15 and Comparative Examples 6 and 7

The same procedure as defined in Example 11 was conducted except that the kinds and amounts of metal oxide particles and magnetic particles, the kinds and amounts of polyethyleneoxide, the kinds and amounts of additives and the kinds and amounts of dispersing media were changed variously, thereby producing magneto rheological fluids.

Essential production conditions are shown in Table 5, and various properties of the obtained magneto rheological fluids are shown in Table 6.

TABLE 5

| Examples, | | | | | |
|---|---|---|---|---|---|
| Com- | Dispersion treatment of magnetic particles | | | | |
| para- | Metal Oxide Particles (C) | | | | |
| tive | | | | BET | |
| Examples | | | Average | specific | |
| and | | | particle | surface | |
| Reference | | | diameter | area | Amount |
| Examples | Kind | Tradename | (nm) | (m²/g) | (g) |
| Example | Silica | FINESEAL T-32 | 15 | 202 | 10 |
| 11 | | (Tokuyama) | | | |
| Example | Alumina | ALUMINA SOL- | 16 | 268 | 15 |
| 12 | | 520 (Nissan | | | |
| | | Kagaku) | | | |
| Example | Silica | AEROGEL R974 | 12 | 180 | 10 |
| 13 | | (Nippon | | | |
| | | Aerogel) | | | |
| Example | Silica | FINESEAL F-80 | 10 | 268 | 12 |
| 14 | | (Tokuyama) | | | |
| Example | Titanium | ST-31 | 7 | 250 | 15 |
| 15 | dioxide | (Ishihara | | | |
| | | Sangyo) | | | |
| Com- | — | — | — | — | — |
| para- | | | | | |
| tive | | | | | |
| Example 6 | | | | | |
| Com- | Silica | FINESEAL T-32 | 202 | 202 | 20 |
| para- | | (Tokuyama) | | | |
| tive | | | | | |
| Example 7 | | | | | |

| Examples, | Dispersion treatment of magnetic particles | | | |
|---|---|---|---|---|
| Comparative | Magnetic particles (A) | | | |
| Examples | | | Average | |
| and | | | particle | |
| Reference | | | diameter | Amount |
| Examples | Kind | Tradename | (μm) | (g) |
| Example 11 | Carbonyl | S-3700 (ISP) | 2.6 | 1000 |
| | iron | | | |
| Example 12 | Carbonyl | S-3000 (ISP) | 1.9 | 1000 |
| | iron | | | |
| Example 13 | Carbonyl | S-3700 (ISP) | 2.6 | 1000 |
| | iron | | | |
| Example 14 | Carbonyl | S-3000 (ISP) | 1.9 | 1000 |
| | iron | | | |
| Example 15 | Carbonyl | S-3000 (ISP) | 1.9 | 1000 |
| | iron | | | |
| Comparative | Carbonyl | S-3700 (ISP) | 2.6 | 1000 |
| Example 6 | iron | | | |
| Comparative | Carbonyl | S-3000 (ISP) | 1.9 | 1000 |
| Example 7 | iron | | | |
| Examples, | | | | |
| Comparative | | | | |
| Examples | Dispersion treatment of magnetic particles | | | |
| and | Weight | Polyethyleneoxide (X) | | Weight ratio |
| Reference | ratio C/A | | Amount | X/A |
| Examples | (%) | Kind | (g) | (%) |
| Example 11 | 1.0 | HI-WAX 4052E | 10 | 1.0 |
| | | (Mitsui Kagaku) | | |
| Example 12 | 1.5 | DISPALON TP-203 | 15 | 1.5 |
| | | (Kusumoto Kasei) | | |
| Example 13 | 1.0 | HI-WAX 4051E | 18 | 1.8 |
| | | (Mitsui Kagaku) | | |
| Example 14 | 1.2 | HI-WAX 2203A | 15 | 1.5 |
| | | (Mitsui Kagaku) | | |
| Example 15 | 1.5 | HI-WAX 4052E | 10 | 1.0 |
| | | (Mitsui Kagaku) | | |
| Comparative | — | — | — | — |
| Example 6 | | | | |
| Comparative | 2.0 | — | — | — |
| Example 7 | | | | |

| Examples, | | | |
|---|---|---|---|
| Comparative | | | |
| Examples | Dispersion treatment of magnetic particles | | |
| and | Additives | | |
| Reference | | | Amount |
| Examples | Kind | Tradename | (g) |
| Example 11 | Bentonite | HYDROCALL ONZ (Allied | 2 |
| | | Colloid) | |
| Example 12 | Bentonite | ESBEN W (Hojun) | 3 |
| Example 13 | — | — | — |
| Example 14 | Amide wax | SN THICKENER 4030 | 3 |
| | | (Sun Nopco) | |
| Example 15 | Bentonite | HYDROCALL ONZ (Allied | 2 |
| | | Colloid) | |
| Comparative | Hydrogenated | DISPALON 305 | 15 |
| Example 6 | castor | (Kusumoto Kasei) | |
| | oil | | |
| Comparative | Bentonite | HYDROCALL ONZ (Allied | 2 |
| Example 7 | | Colloid) | |

| | |
|---|---|
| Examples, | |
| Comparative | Dispersion treatment of |
| Examples | magnetic particles |
| and | Solvent |

| Reference | | Amount |
|---|---|---|
| Examples | Tradename | (g) |
| Example 11 | SUPER OIL M10 | 240 |
| | (Shin-Nihon Sekiyu) | |
| Example 12 | SUPER OIL M10 | 220 |
| | (Shin-Nihon Sekiyu) | |
| Example 13 | TURBINE OIL 46 | 250 |
| | (Shin-Nihon Sekiyu) | |
| Example 14 | TURBINE OIL 46 | 300 |
| | (Shin-Nihon Sekiyu) | |
| Example 15 | CRYSEF OIL F22 | 260 |
| | (Shin-Nihon Sekiyu) | |
| Comparative | TURBINE OIL 46 | 300 |
| Example 6 | (Shin-Nihon Sekiyu) | |
| Comparative | CRYSEF OIL F22 | 250 |
| Example 7 | (Shin-Nihon Sekiyu) | |

TABLE 6

| Examples, | | | | |
|---|---|---|---|---|
| Comparative | Content of | | | |
| Examples | magnetic | Viscosity | | |
| and | particles | (shear rate: | | Sedimentation |
| Reference | (% by | 100 sec⁻¹) | Thixotropy | degree |
| Examples | volume) | (mP · s) | index | (mL) |
| Example 11 | 31 | 285 | 7 | 1.0 |
| Example 12 | 33 | 254 | 6 | 1.2 |
| Example 13 | 30 | 326 | 11 | 1.4 |
| Example 14 | 27 | 248 | 6 | 1.8 |
| Example 15 | 31 | 325 | 14 | 1.5 |
| Comparative | 27 | 296 | 3 | 10.2 |
| Example 6 | | | | |
| Comparative | 32 | 450 | 3 | 7.2 |
| Example 7 | | | | |

Meanwhile, the commercial products (tradenames) and makers of the respective components used in Examples 12 to 15, Comparative Examples 6 and 7 and Reference Example 4 were as follows.

Oils:

“SUPER OIL M10”: Shin-Nihon Sekiyu Co., Ltd.;

“TURBINE OIL 46”: Shin-Nihon Sekiyu Co., Ltd.;

“CRYSEF OIL F22”: Shin-Nihon Sekiyu Co., Ltd.

Polyethyleneoxides:

“HIGH-WAX 4052E”: Mitsui Kagaku Co., Ltd.;

“HIGH-WAX 4051E”: Mitsui Kagaku Co., Ltd.;

“HIGH-WAX 2203A”: Mitsui Kagaku Co., Ltd.;

“DISPALON TP-203”: Kusumoto Kasei Co., Ltd.

Hydrogenated Castor Oils:

“SN THICKENER 4040”: Sun Nopco Co., Ltd.;

“DISPALON TP-305”: Kusumoto Kasei Co., Ltd.

Bentonites:

“ESBEN W”: Hojun Co., Ltd.;

“ESBEN P”: Hojun Co., Ltd.;

“ESBEN N-400”: Hojun Co., Ltd.;

“HYDROCALL ONZ”: Allied Colloid Inc.

Amide Wax:

“SN THICKENER 4020”: Sun Nopco Co., Ltd.

<Magneto Rheological Fluid According to the Fourth Aspect of the Present Invention>

### Example 16

(Preparation of Magnetite Paste)

620 mL of a 0.9M FeSO₄ aqueous solution and 620 mL of a 1.8M FeCl₃ aqueous solution were dropped into 2760 mL of a 3.27N NaOH aqueous solution adjusted to 60° C. while stirring, and then the resultant mixed solution was aged at 60° C. for one hour. Then, the obtained reaction solution was cooled, thereby obtaining a slurry containing magnetite particles having a particle diameter of 10 nm in an amount of 5% by weight.

1200 g of the resultant slurry was mixed with 75 g of a 20% sodium oleate solution, and the resultant slurry was stirred at 70° C. for 30 min. After stopping the temperature control, the obtained slurry was mixed with 200 g of toluene, and then with a 0.35N dilute sulfuric acid to transfer the magnetite from a water phase to a toluene phase, i.e., subject the slurry to a so-called flushing treatment. Next, after removing the water phase, the magnetite slurry was taken out of the toluene phase.

The resultant slurry was mixed with 30 g of a paraffin-based oil “TURBINE OIL M46™” produced by Shin-Nihon Sekiyu Co., Ltd., and 3 g of oleic acid, and the obtained mixture was dispersed for 5 min using a homomixer.

The thus dispersed slurry was treated by an evaporator to remove toluene therefrom, thereby obtaining an oil-based paste containing magnetite in an amount of 54% by weight.

(Preparation of Magneto Rheological Fluid)

Next, 4 g of polyethyleneoxide “HIGH-WAX 1105A™” produced by Mitsui Kagaku Co., Ltd., which was previously melted at 120° C., and 220 g of a paraffin-based oil “CRYSEF OIL F22” were mixed with 29 g of the above oil-based magnetite paste, 1000 g of carbonyl iron “S3000™” produced by ISP Co., Ltd., 2 g of bentonite “HYDROCALL ONZ™” produced by Allied Colloid Inc., and 7.2 g of oleic acid, and the resultant mixture was dispersed at a temperature of not more than 40° C. for 40 min using a homomixer, followed by heating the mixture to 70° C. for 20 min. Then, the obtained reaction mixture was naturally cooled to room temperature, and then mixed with 10 g of “CRYSEF OIL F22”. The resultant mixture was mixed and dispersed for 5 min using a homomixer, thereby preparing a magneto rheological fluid containing carbonyl iron in an amount of 35% by volume.

Essential production conditions are shown in Table 10, and various properties of the thus obtained magneto rheological fluid are shown in Table 11. It was confirmed that the resultant magneto rheological fluid had a viscosity of 450 mPa, a yield value of 50 dyn/cm², a thixotropy index of 3 and a dispersibility of 1.0 mL.

As shown from a micrograph of the obtained magnetic particles, the fine magnetite particles were adhered in the form of a coating layer onto the surface of the respective carbonyl ion particles.

### Example 17

The same procedure as defined in Example 16 was conducted except that 12 g of silica “FINE SEAL T-32™” produced by Tokuyama Co., Ltd., was used instead of the magnetite paste, and 15 g of polyethyleneoxide “DISPALON TP-20™” produced by Kusumoto Kasei Co., Ltd., 3 g of bentonite “ESBEN W™” produced by Hojun Co., Ltd., and an oil “SUPER OIL M10™” produced by Shin-Nihon Seiyu Co., Ltd., were respectively used, thereby producing a magneto rheological fluid.

### Examples 18 and 19 and Comparative Examples 8 to 10

The same procedure as defined in Example 16 was conducted except that the kinds and amounts of magnetic particles and fine inorganic particles, the kinds and amounts of polyethyleneoxides, the kinds and amounts of additives and the kinds and amounts of dispersing media were changed variously, thereby producing magneto rheological fluids.

Essential production conditions are shown in Table 7, and various properties of the obtained magneto rheological fluids are shown in Table 8.

TABLE 7

| | Dispersion treatment of magnetic particles | | | | |
|---|---|---|---|---|---|
| Examples, | Fine inorganic particles (D) | | | | |
| Comparative | | | | BET | |
| Examples | | | Average | specific | |
| and | | | particle | surface | |
| Reference | | | diameter | area | Amount |
| Examples | Kind | Tradename | (nm) | (m²/g) | (g) |
| Example 16 | Iron | Magnetite | 10 | 120 | 16 |
| | oxide | | | | |
| Example 17 | Silica | FINESEAL | 10 | 288 | 12 |
| | | F-80 | | | |
| | | (Tokuyama) | | | |
| Example 18 | Iron | Magnetite | 10 | 120 | 10 |
| | oxide | | | | |
| Example 19 | Titanium | ST-31 | 7 | 250 | 15 |
| | dioxide | (Ishihara | | | |
| | | Sangyo) | | | |
| Comparative | — | — | — | — | — |
| Example 8 | | | | | |
| Comparative | Iron | Magnetite | 10 | 202 | 20 |
| Example 9 | oxide | | | | |

| Examples, | Dispersion treatment of magnetic particles | | | |
|---|---|---|---|---|
| Comparative | Magnetic particles (A) | | | |
| Examples | | | Average | |
| and | | | particle | |
| Reference | | | diameter | Amount |
| Examples | Kind | Tradename | (μm) | (g) |
| Example 16 | Carbonyl | S-3000 (ISP) | 1.9 | 1000 |
| | iron | | | |
| Example 17 | Carbonyl | S-3000 (ISP) | 1.9 | 1000 |
| | iron | | | |
| Example 18 | Carbonyl | S-3700 (ISP) | 2.6 | 1000 |
| | iron | | | |
| Example 19 | Carbonyl | S-3000 (ISP) | 1.9 | 1000 |
| | iron | | | |
| Comparative | Carbonyl | S-3700 (ISP) | 2.6 | 1000 |
| Example 8 | iron | | | |
| Comparative | Carbonyl | S-3000 (ISP) | 1.9 | 1000 |
| Example 9 | iron | | | |
| Examples, | | | | |
| Comparative | | | | |
| Examples | Dispersion treatment of magnetic particles | | | |
| and | Weight | Polyethyleneoxide (X) | | Weight ratio |
| Reference | ratio D/A | | Amount | X/A |
| Examples | (%) | Kind | (g) | (%) |
| Example 16 | 1.6 | HI-WAX 1105A | 10 | 1.0 |
| | | (Mitsui Kagaku) | | |
| Example 17 | 1.2 | DISPALON TP-203 | 15 | 1.5 |
| | | (Kusumoto Kasei) | | |
| Example 18 | 1.0 | HI-WAX 4051E | 18 | 1.8 |
| | | (Mitsui Kagaku) | | |
| Example 19 | 1.5 | HI-WAX 4052E | 15 | 1.0 |
| | | (Mitsui Kagaku) | | |
| Comparative | — | — | — | — |
| Example 8 | | | | |
| Comparative | 2.0 | — | — | — |
| Example 9 | | | | |

| Examples, | | | |
|---|---|---|---|
| Comparative | | | |
| Examples | Dispersion treatment of magnetic particles | | |
| and | Additives | | |
| Reference | | | Amount |
| Examples | Kind | Tradename | (g) |
| Example 16 | Bentonite | HYDROCALL ONZ (Allied | 2 |
| | | Colloid) | |
| Example 17 | Bentonite | ESBEN W (Hojun) | 3 |
| Example 18 | — | — | — |
| Example 19 | Bentonite | SN THICKENER 4030 | 3 |
| | | (Sun Nopco) | |
| Comparative | Hydrogenated | DISPALON 305 | 15 |
| Example 8 | castor | (Kusumoto Kasei) | |
| | oil | | |
| Comparative | Bentonite | HYDROCALL ONZ (Allied | 2 |
| Example 9 | | Colloid) | |

| | |
|---|---|
| Examples, | |
| Comparative | Dispersion treatment of |
| Examples | magnetic particles |
| and | Solvent |

| Reference | | Amount |
|---|---|---|
| Examples | Tradename | (g) |
| Example 16 | CRYSEF OIL F22 | 230 |
| | (Shin-Nihon Sekiyu) | |
| Example 17 | SUPER OIL M10 | 220 |
| | (Shin-Nihon Sekiyu) | |
| Example 18 | TURBINE OIL 46 | 250 |
| | (Shin-Nihon Sekiyu) | |
| Example 19 | CRYSEF OIL F22 | 260 |
| | (Shin-Nihon Sekiyu) | |
| Comparative | TURBINE OIL 46 | 300 |
| Example 8 | (Shin-Nihon Sekiyu) | |
| Comparative | CRYSEF OIL F22 | 250 |
| Example 9 | (Shin-Nihon Sekiyu) | |

TABLE 8

| Examples, | | | |
|---|---|---|---|
| Comparative | | | |
| Examples | Content of | | Viscosity |
| and | magnetic | Saturation | (shear rate: |
| Reference | particles | magnetization | 100 sec⁻¹) |
| Examples | (% by volume) | (mT) | (mP · s) |
| Example 16 | 33 | 204 | 298 |
| Example 17 | 33 | 205 | 307 |
| Example 18 | 31 | 203 | 357 |
| Example 19 | 30 | 198 | 364 |
| Comparative | 27 | 197 | 296 |
| Example 8 | | | |
| Comparative | 32 | 201 | 450 |
| Example 9 | | | |

| Examples, | | | |
|---|---|---|---|
| Comparative | | | |
| Examples | | | |
| and | | | Sedimentation |
| Reference | Yield value | Thixotropy | degree |
| Examples | (dyne/cm²) | index | (mL) |
| Example 16 | 45 | 6 | 1.0 |
| Example 17 | 15 | 7 | 1.2 |
| Example 18 | 24 | 5 | 1.1 |
| Example 19 | 19 | 8 | 1.3 |
| Comparative | 225 | 3 | 10.2 |
| Example 8 | | | |
| Comparative | 277 | 3 | 7.2 |
| Example 9 | | | |

Meanwhile, the commercial products (tradenames) and makers of the respective components used in Examples 17 to 19 and Comparative Examples 8 to 10 were as follows.

Oils:

“SUPER OIL M10”: Shin-Nihon Sekiyu Co., Ltd.;

“TURBINE OIL 46”: Shin-Nihon Sekiyu Co., Ltd.;

“CRYSEF OIL F22”: Shin-Nihon Sekiyu Co., Ltd.

Polyethyleneoxides:

“HIGH-WAX 1105E”: Mitsui Kagaku Co., ltd.;

“HIGH-WAX 4052E”: Mitsui Kagaku Co., Ltd.;

“HIGH-WAX 4051E”: Mitsui Kagaku Co., Ltd.;

“DISPALON TP-203”: Kusumoto Kasei Co., Ltd.

Hydrogenated Castor Oils:

“SN THICKENER 4040”: Sun Nopco Co., Ltd.;

“DISPALON TP-305”: Kusumoto Kasei Co., Ltd.

Bentonites:

“ESBEN W”: Hojun Co., Ltd.;

“HYDROCALL ONZ”: Allied Colloid Inc.

Amide Wax:

“SN THICKENER 4020”: Sun Nopco Co., Ltd.

What is claimed is:

1. A magneto rheological fluid comprising magnetic particles, a dispersing medium and polyethyleneoxide as a viscosity modifier, said polyethyleneoxide being contained in an amount of 0.5 to 5% by weight based on the weight of the magnetic particles.

2. A magneto rheological fluid according to claim 1, further comprising at least one additive selected from the group consisting of hydrogenated castor oils, amide waxes, montmorillonite and bentonite.

3. A magneto rheological fluid according to claim 1, wherein said magnetic particles are at least one kind of particles selected from the group consisting of alloy particles containing at least two elements selected from the group consisting of iron, cobalt and nickel; metal compound particles containing at least one element selected from the group consisting of iron, cobalt and nickel; iron particles; iron nitride particles; iron carbide particles; carbonyl iron particles; ferrite particles; and magnetite particles.

4. A magneto rheological fluid according to claim 1, wherein said dispersing medium is a hydrocarbon-based solvent, a glycol-based solvent or a silicone-based solvent.

5. A magneto rheological fluid according to claim 1, wherein said magneto rheological fluid has a thixotropy index of not less than 5.

6. A magneto rheological fluid according to claim 1, wherein a content of the magnetic particles in the dispersing medium is in the range of 15 to 40% by volume, and an amount of the polyethyleneoxide blended is in the range of 0.5 to 3% by weight based on the weight of the magnetic particles.

7. A magneto rheological fluid according to claim 1, wherein said magneto rheological fluid contains a surfactant or a higher-fatty acid.

8. A magneto rheological fluid according to claim 1, wherein said magnetic particles contain fine magnetic particles having an average particle diameter of 5 to 15 nm and magnetic particles having an average particle diameter of 0.3 to 10 μm, and a blending weight ratio of the fine magnetic particles to the magnetic particles is in the range of 0.8:100 to 15:100.

9. A magneto rheological fluid according to claim 8, wherein the fine magnetic particles have an average particle diameter of 7 to 10 nm and the magnetic particles have an average particle diameter of 0.4 to 5 μm, and a blending weight ratio of the fine magnetic particles to the magnetic particles is in the range of 1:100 to 10:100.

10. A magneto rheological fluid according to claim 1, wherein said magneto rheological fluid further contains metal oxide particles having an average particle diameter of 2 to 50 nm, said magnetic particles have an average particle diameter of 0.1 to 10 μm, and a blending weight ratio of the metal oxide particles to the magnetic particles is in the range of 0.8:100 to 15:100.

11. A magneto rheological fluid according to claim 10, wherein said metal oxide particles are selected from the group consisting of silica particles, alumina particles and titanium oxide particles.

12. A magneto rheological fluid according to claim 10, wherein said magnetic particles have an average particle diameter of 0.3 to 5 μm, said metal oxide particles have an average particle diameter of 5 to 50 nm, and a blending weight ratio of the metal oxide particles to the magnetic particles is in the range of 0.8:100 to 10:100.

13. A magneto rheological fluid according to claim 1, wherein said magnetic particles are composite magnetic particles comprising magnetic particles having an average particle diameter of 0.3 to 10 μm, and fine inorganic particles covering surface of the respective magnetic particles and having an average primary particle diameter of 5 to 20 nm, and a blending weight ratio of the fine inorganic particles to the magnetic particles is in the range of 0.8:100 to 15:100.

14. A magneto rheological fluid according to claim 13, wherein said fine inorganic particles are composed of iron oxide.

15. A magneto rheological fluid according to claim 13, wherein said fine inorganic particles are selected from the group consisting of silica particles, alumina particles and titanium oxide particles.

16. A magneto rheological fluid according to claim 13, wherein said composite magnetic particles have an average particle size of 0.3 to 10 μm, said fine inorganic particles have an average primary particle diameter of 5 to 15 nm, and a ratio of a thickness of a coating layer composed of the fine inorganic particles to a diameter of the respective magnetic particles as core particles is in the range of 5:10000 to 20:100.
